(19) United States
(12) Patent Application Publication
(10) Pub. No.: US 2004/0024785 A1
(43) Pub. Date: Feb. 5, 2004

(54) Method of transferring data files

(75) Inventor: Robert John Castle, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD DEVELOPMENT COMPANY L.C.

(21) Appl. No.: 10/629,757

(22) Filed: Jul. 30, 2003

(30) Foreign Application Priority Data
Jul. 31, 2002 (GB) 0217803.6

(51) Int. Cl. G06F 7/00

(52) U.S. Cl. 707/104.1

(57) ABSTRACT

An on-board computer system is accessible by means of a plurality of on-board computer workstations. Data files can be used on this system by transferring them from a personal computer to the on-board computer system and then enabling access to the data files in accordance with identification information inputted to the on-board computer system.

### FIELD OF THE INVENTION

This invention relates to a method of transferring data files, and particularly to a method of transferring data files from a personal computer to a computer system which is on-board a passenger vehicle or craft.

### BACKGROUND OF THE INVENTION

Security is an important issue in the field of passenger transportation, particularly in relation to air, sea and rail transportation. Security measures are necessary to prevent, or at least significantly reduce, the risks associated with terrorism and other illegal activities such as smuggling. For example, it has long been the case that airports have relatively high levels of security, with x-ray machines and metal detectors being employed. However, such systems are still unable to guarantee total security.

Given this fact, it has becoming increasingly common for passengers to be prevented from taking hand-luggage and/or electronic equipment into the passenger compartment of the vehicle or craft. Indeed, in aircraft, it is common for airlines to require all luggage to be stored in the cargo hold. This can be inconvenient for travellers who wish to use computer devices during transit. In particular, many business travellers wish to access their own data files and work aboard the vehicle or craft during transit, particularly if they are travelling on a long journey, e.g. on a long-haul flight.

In addition to security considerations, it is also desirable for passengers, particularly passengers travelling for business purposes, to be able to work co-operatively with others. For example, a group of business colleagues travelling together may wish to access a shared set of files so that they can work efficiently. However, conventional means of setting up temporary computer networks are unsuitable for vehicles or craft. Radio links can cause interference with the electronics of the vehicle or craft (this being a particular concern on aircraft). Infra-red links require a line-of-sight connection between computers, which also have to be in close proximity with one other. The use of physical cable connections is highly undesirable since the cables add to the amount of luggage carried and, realistically, will require the computers to be close to one another so that the cables are not strewn over the passenger compartment.

### SUMMARY OF THE INVENTION

According to the invention, a method is proposed whereby a user transfers one or more data files from their personal computer to a computer system on-board a passenger vehicle or craft, the or each data file being accessible from the on-board computer system by means of one or more computer workstations connected to the on-board computer system. In this regard, the vehicle or craft may include one or more dedicated computer workstations for passenger use during transit. For example, a workstation display may be provided as part of the rear surface of a seat so that a user facing the rear surface of the seat can view the display and operate the workstation using a keyboard or other controller which is provided, for example, as part of the user's own seat, or on a flip-down tray on the rear surface of the seat in-front. The on-board computer system can be specific to each workstation, or, as is perhaps more efficient, the on-board computer system can be a central server which can be accessed by each of the plurality of computer workstations.

According to one aspect of the invention, there is provided a method of providing access to at least one data file using a computer system on-board a passenger vehicle or craft, said on-board computer system being accessible by means of a plurality of on-board computer workstations, the method comprising the steps of: receiving into said on-board computer system at least one data file previously stored in a personal computer; and enabling access to the at least one data file in said on-board computer system by means of at least one of the on-board computer workstations, which access is enabled in accordance with identification information inputted to said on-board computer system.

According to another aspect of the invention, there is provided a method of transferring at least one data file to a computer system on-board a passenger vehicle or craft, which on-board computer system is accessible by means of a plurality of on-board computer workstations, the method comprising the steps of: transferring the at least one data file from a personal computer to the on-board computer system; and providing identification information to said on-board computer system so as to indicate at least one on-board computer workstation by which said at least one data file may be accessed.

According to another aspect of the invention, there is provided a computer network on-board a passenger vehicle or craft, the computer network comprising: a first data port; an on-board computer system connected to the first port; and a plurality of on-board workstations connected to said on-board computer system, said on-board computer system being arranged to receive at least one data file from a personal computer by means of the first port, and to enable access to the at least one data file on said on-board computer system by means of at least one on-board computer workstation, said on-board computer system being arranged to enable access in accordance with identification information contained in the at least one data file.

According to another aspect of the invention, there is provided a method of providing access to one or more data files using a computer system on-board a passenger vehicle or craft, the on-board computer system being accessible by means of a plurality of on-board computer workstations, the method comprising: transferring the or each data file from a personal computer to the on-board computer system; and enabling access to the or each data file on the on-board computer system by means of a selected one or a selected group of the on-board computer workstations, the access being enabled in accordance with identification information inputted to the on-board computer system.

The method provides a means whereby data files can be transferred from a personal computer to an on-board computer system for subsequent access by a user, the access being dependant on identification information inputted to the on-board computer system. Thus, access to data files can be limited to one or more people. In effect, a Local Area Network (LAN) can be set up on-board the vehicle or craft to suit the requirements of its users. It is important to be able to limit the access rights to the data file or files, particularly if they relate to confidential business information. The fact that users' personal computer systems do not have to be brought onto the vehicle or craft also means that security requirements of vehicle or craft operators is not compromised.

The step of transferring the or each data file from the personal computer to the on-board computer system may comprise: transferring the or each data file from the personal computer to a check-in computer system; at the check-in computer system, adding the identification information to the or each data file; and transferring the or each data file and the added identification information to the on-board computer system. In this way, the identification data is specified at the check-in terminal prior to being transferred and so inputted to the on-board computer system.

The step of adding identification information to the or each data file may comprise adding data identifying one or more of the on-board computer workstations, the or each data file thereafter being accessible from the on-board computer only by means of those on-board computer workstations specified in the identification data.

The check-in computer system may be located external to the vehicle or craft, and the identification data can be generated in accordance with a user's check-in information. The identification data can be generated in accordance with a user's predetermined seat number, the or each data file being accessible only by means of one or more on-board computer workstations associated with the user's seat number. It will be understood that the identification data will usually relate to the workstation located directly in front of the user's seat.

Alternatively, or additionally, the step of adding identification information to the or each data file can comprise assigning a user password to the or each data file, the or each data file thereafter being accessible from the on-board computer system only by means of those on-board computer workstations where the user password is entered using an input device associated with the or each workstation.

The or each data file can be encrypted prior to being transferred to the on-board computer system, and, at the on-board computer system, the or each data file can be decrypted in accordance with the user password being entered at one or more of the on-board computer workstations, the or each decrypted data file being accessible only by means of those computer workstations where the user password is entered.

The check-in computer system can be located external to the passenger vehicle or craft, the user password being specific to the user who transfers the or each data file to the check-in computer system. The user password can be generated randomly at the check-in computer system and thereafter identified to the user. After the user password is randomly generated, the user password can be printed onto a pass for user collection.

The user password can be specified by the user at, or prior to arriving at, the check-in computer system. For example, the user may specify their chosen password when booking their ticket or through some secure Internet page.

The step of adding identification information to the or each data file may comprise (i) adding, to the or each data file, data specifying one or more of the on-board computer workstations, and (ii) assigning a user password to the or each data file, wherein the or each data file is thereafter accessible from the on-board computer only by means of those on-board computer workstations (a) which are specified in the added data, and (b) to which the user password is entered using an input device associated with the or each workstation.

The step of transferring the or each data file from the personal computer to the on-board computer system may comprise: transferring the or each data file from the personal computer to a portable storage medium; and using a reading device on-board the vehicle or craft to read the or each data file from the portable storage medium to the on-board computer system. The portable storage medium may be a CD-ROM and the on-board reading device may be a CD-ROM drive. Alternatively, the portable storage medium can be a floppy disk and the on-board reading device can be a floppy disk drive.

The method may further comprise transferring the or each data file from the on-board computer system to a personal computer located external to the vehicle or craft.

According to another aspect of the present invention, there is provided a computer network on-board a passenger vehicle or craft, the computer network comprising: a first data port; an on-board computer system connected to the first port; and a plurality of on-board workstations connected to the on-board computer system, the on-board computer system being arranged (a) to receive one or more data files from a personal computer by means of the first port, and (b) to enable access to the or each data file on the on-board computer system by means of a selected one or a selected group of the on-board computer workstations.

The on-board computer system may be arranged to enable access to the or each data file only by means a selected one or group of the on-board computer workstations in accordance with identification information contained in the or each data file. The identification information may specify a predetermined one or group of the on-board computer workstations, the on-board computer system being arranged to enable access to the or each data file only by means of those computer workstations specified.

The identification information may comprise a user password assigned to the or each data file, the on-board computer system allowing access to the or each data file by means of only those on-board computer workstations where the user password is entered using an input device associated with the or each workstation. The first data port can be configured to be connectable to an external check-in computer system to which the personal computer can be connected.

The first data port can be a storage media reading device arranged to read data files from a portable storage device. The reading device can be a disk drive.

The first data port may be further arranged to transmit data from the on-board computer system to a personal computer located external to the vehicle or craft.

The on-board computer workstations may each comprise a display and a user input device. The display is preferably mounted on the reverse side of a passenger seat. The user input device preferably comprises a keyboard mounted on a frame which is pivotally attached to the reverse side of a passenger seat, the frame being pivotable between a first position whereby the keyboard can be operated, and a second position whereby the keyboard is stowed away.

### BRIEF DESCRIPTION OF THE DRAWINGS

The invention will now be described, by way of example, with reference to the accompanying drawings, in which:

FIG. 1 is a schematic diagram showing an aircraft situated adjacent an airport check-in bay;

FIGS. 2a and 2b show, respectively, a rear view and a side view of a passenger seat of the aircraft shown in FIG. 1; and

FIG. 3 is a schematic diagram showing an aircraft situated adjacent a further airport check-in bay.

### DETAILED DESCRIPTION OF THE PREFERRED EMBODIMENTS

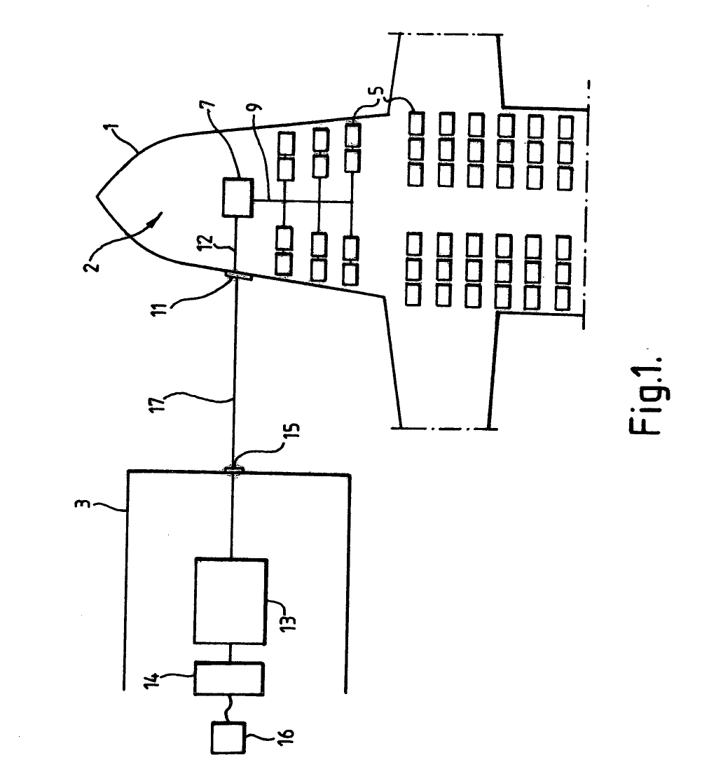

Referring to FIG. 1, an aircraft 1 is shown adjacent a check-in bay 3 of an airport. As will be appreciated, the check-in bay 3 is a room within which passengers remain until the aircraft 1 is ready to be boarded. The aircraft 1 comprises a passenger compartment 2 within which are provided a plurality of passenger seats 5. The aircraft 1 further comprises an on-board computer network based around a computer system 7 which includes a server running dedicated software. Each passenger seat 5 has a computer workstation (not shown in FIG. 1) provided as part of the seat, each computer workstation including a display screen, a keyboard input device and a disk drive. The on-board computer system 7 is connected to each of the computer workstations by means of network cables 9 running beneath the floor panels of the aircraft 1. Connections to only the front twelve passenger seats 5 are shown in FIG. 1. The network cables 9 are electromagnetically shielded so as not to interfere with other electrical or electrical components of the aircraft 1.

On an outer surface of the aircraft 1, a connection port 11 is provided. The connection port 11 is connected to the on-board computer system 7 by means of a network connection 12 and permits bi-directional data transfer between the on-board computer system 7 and computer devices external to the aircraft 1. The connection port 11 can be situated at a convenient part of the aircraft exterior, for example, adjacent diagnostic ports which are used by engineers to check various electronic components of the aircraft 1.

Within the check-in bay 3 is provided a PC check-in terminal 13. The PC check-in terminal 13 comprises a connection interface 14 which can be connected to conventional laptop PCs, PDAs or other personal or portable computer devices (hereafter referred to as ‘portable computers’). The PC check-in terminal also comprises an internal memory (not shown) onto which one or more data files can be stored, the or each data file being read from a portable computer device which is connected to the connection interface 14. The PC check-in terminal 13 is connected to a bay port 15 which is temporarily connected to the connection port 11 of the aircraft 1, by means of a cable 17. Alternatively, the PC check-in terminal 13 could be connected to the check-in bay 3 by means of a wireless link, e.g. set up using a wireless LAN protocol.

In use, a passenger in the check-in bay 3 connects his own portable computer 16 to the connection interface 14 of the PC check-in terminal 13, and then transfers one or more files from the portable computer to the internal memory of the PC check-in terminal.

The portable computer 16 can then be passed to aircraft staff or security so that it can be stowed in a secure storage compartment of the aircraft 1. As will be explained below, the or each data file which is stored on the memory of the PC check-in terminal 13 is thereafter transferred to the on-board computer system 7 of the aircraft by means of the bay port 15, the cable 17, and the connection port 11.

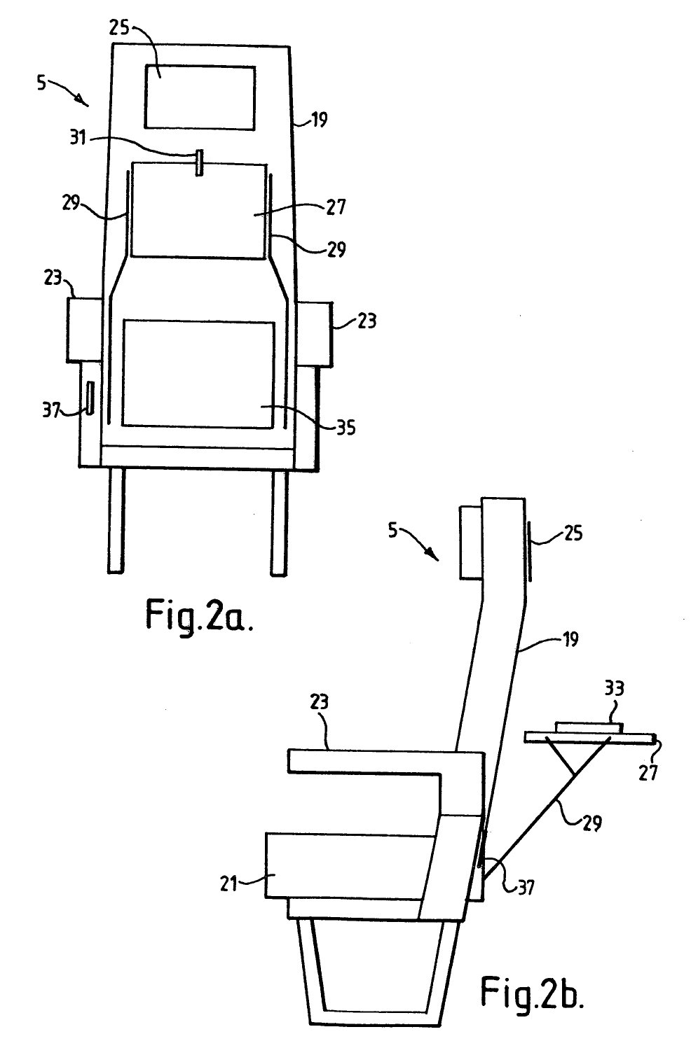

Referring now to FIGS. 2a and 2b, each passenger seat of the aircraft 1 includes a generally upright back rest 19 and a generally horizontal seat platform 21. Two arm rests 23 are provided either side of the seat platform 21. On a reverse side of the back rest 19 is provided a colour Liquid Crystal Display (LCD) screen 25 which forms part of the computer workstation (mentioned above). A tray 27 is provided, the tray being pivotally attached to a lower part of the back rest 19 by two tray arms 29. On an upper surface of the tray 27 is provided a computer keyboard 33, the input device of the computer workstation. The tray 27 is able to move between two main positions. In the first position, shown in FIG. 2a, the tray 27 is held against the back of the back rest by a rotatable clip 31 which prevents the tray 27 from falling downwards under its own weight. In this position, the keyboard 33 is securely stowed away. In the second position, shown in FIG. 2b, the tray 27 is positioned so as to be substantially horizontal with the keyboard 33 exposed and ready for use. The second position is achieved by simply rotating the clip 31 until the tray 27 falls down under its own weight. The tray arms 29 can be damped, e.g. using hydraulic pistons, so that the tray 27 falls in a controlled manner. A disk drive 37 is provided on the reverse side of the seat platform. The disk drive 37 is arranged to receive floppy disks for accessing data stored thereon, as will be explained below.

In an alternative arrangement, the upper surface of the tray 27 can be configured as a conventional support tray, i.e. a platform on which food and/or drinks can be supported during the flight. In this case, the computer keyboard 33 is arranged on the reverse side of the tray 27. The tray 27 is rotatably mounted to the tray arms 29 so that the tray can be flipped over, either backwards or forwards, to alternate between the support configuration, and the keyboard configuration.

As indicated above, the display screen 25, the keyboard 23 and the disk drive 37 together comprise a computer workstation. Although the computer workstation is physically provided on the passenger seat 5 shown in FIGS. 2a and 2b, the passenger using the computer workstation will actually be seated in the seat directly behind the passenger seat shown.

A first preferred method, by which a passenger can use the system shown in FIG. 1, will now be described.

Initially, when a passenger arrives at the airport, the passenger will check-in as usual at a check-in desk. If the passenger is carrying a portable computer 16 as part of his luggage, the passenger then specifies whether or not he wishes to access files from the portable computer when on-board the aircraft 1. If so, the passenger is issued with a password with his boarding pass, the password enabling access to a temporary account which is set up for the passenger's specific use. When the account is set up, an area of memory is assigned to the passenger at the PC check-in terminal 13, and at the on-board computer system 7. In order to access the memory area at the check-in terminal 13, or at the on-board computer system 7, the passenger has to enter his password, as will be explained below.

After checking-in, the passenger proceeds to the PC check-in terminal 13 in the check-in bay 3. The PC check-in terminal 13 is kept separate from the conventional airport check-in desk, so as not to cause delay to other passengers.

At the PC check-in terminal 13, the passenger connects his portable computer 16 to the connection interface 14. The passenger also enters his password to identify himself to the PC check-in terminal 13. A graphical user interface (GUI) of the PC check-in terminal 13 displays a browser so that the passenger can specify the or each file which he wishes to use when on-board the aircraft 1. Once the or each data file is specified, the data is transferred to the area of the check-in terminal's internal memory which is assigned to the passenger's account. The passenger can then disconnect the portable computer 16 from the PC check-in terminal 13.

In the next stage, the or each data file is transferred from the PC check-in terminal 13 to the on-board computer system 7 by means of the bay port 15, the connecting cable 17, the connection port 11, and the network connection 12. The or each data file is stored on the memory of the on-board computer system 7, at a location pre-assigned to the passenger's account. Once the aircraft 1 is disconnected from the check-in bay 3, data files stored on the internal memory of the check-in terminal 13 are erased. Alternatively, the PC check-in terminal 13 could be set with a time-lapse so that all data is erased automatically after a set time period. Thus, no sensitive files remain at the PC check-in terminal 13.

Prior to boarding the aircraft 1, the passenger deposits his personal computer with the airline staff or security so that it may be securely stored in the passenger hold of the aircraft.

When inside the passenger compartment 2 of the aircraft 1, the passenger is seated in the designated passenger seat 5. When the passenger wishes to work on his data file or files, he rotates the clip 31 so that the tray 27 falls down from the first position, to the second position shown in FIG. 2b. By pushing a button on the keyboard 33, the computer workstation is enabled and the display screen 25 shows a log-in screen. The passenger then accesses his file or files, stored on the on-board computer system 7, by entering the password assigned to him at check-in. If the incorrect password is entered, an error message appears. A software program running on the on-board computer system 7 is arranged to handle the security verification. Provided the entered password matches the password assigned to the passenger at check-in, the passenger's account is opened and a list of data files stored under the open account is displayed. Then, the passenger simply selects the required file and begins working as normal.

In situations where several passengers wish to work cooperatively, that is, they wish to have access to one or more shared files, each of the passengers simply input the designated password to the respective computer workstation 5. Effectively, the system enables a LAN to be established over the network on the aircraft 1.

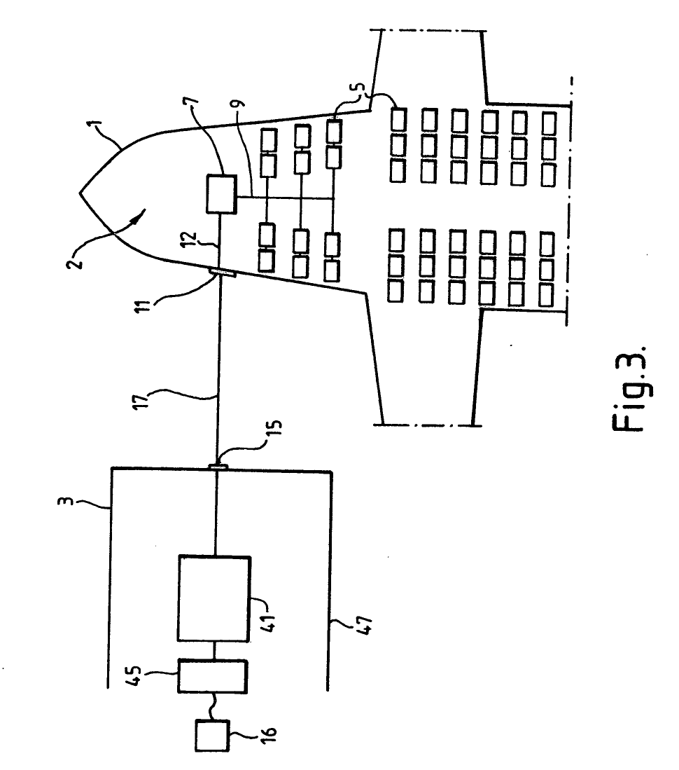

Referring to FIG. 3, a further check-in bay 47 of a destination airport is shown. At the end of the aircraft's journey, the data files stored on the on-board computer system 7 (some of which would have been modified by the passenger in the course of the journey) are transferred to a further PC check-in terminal 41 in the check-in bay 47 of the destination airport. This further PC check-in terminal 41 also comprises an internal memory (not shown) and a connection interface 45. Again, a temporary account is setup at the destination PC check-in terminal 41 and the or each data file is sent to an area of memory preassigned to the passenger's account.

Having disembarked from the aircraft 1, the passenger collects his portable computer from a baggage collection point and then connects his portable computer to the PC check-in terminal 41 using a connection interface 45 as before. The passenger is prompted to enter his password (given to him at the initial check-in at the departure airport) whereafter the passenger's account is opened, and the data files are written back to his portable computer 16. In the case of files which have been modified in the course of the aircraft's journey, it will be necessary for the PC check-in terminal 41 to synchronise the modified data files with the ‘old’ versions stored on the portable computer 16. This is performed in much the same way as happens with conventional PDA's which interact and share information with host PCs. Once the passenger disconnects the portable computer from the PC check-in terminal 41, the internal memory of the check-in terminal is erased, as is the memory of the on-board computer system 7.

A second preferred embodiment will now be described. In this embodiment, the method employed is similar to that above, but in this case, an account does not have to be set up in advance. In this case, security information is added to the or each data file at the time when the passenger transfers the or each data file to the PC check-in terminal 13. Where there are a plurality of data files, a set of security information can be added to each data file, or to a batch of data files. The security information effectively specifies the passenger, or group of passengers, that can access the or each data file at the on-board computer system 7. Thus, the security information which is added to the or each data file defines an access profile defining who may access and operate on the or each data file.

The security information may be defined in a number of different ways. One way is simply to attach the account password, given at the initial check-in desk, to the or each data file. In order to access the or each transferred data file (i.e. the same data file with the added security information) thereafter, the password is required to be entered.

As with any password method, including the one described in the first embodiment, if the user wishes to specify his own password, i.e. in preference to the one given at check-in, he may do so at the PC check-in terminal 13 using a keypad. It could even be arranged that passengers, if booking their tickets in advance using an Internet site, specify their own password using the site.

As an alternative to the password method, the security information can relate to the identity of one or more of the computer workstations on-board the aircraft 1. Thus, each computer workstation may have its own identity number, perhaps corresponding to the passenger seat 5 located directly behind the computer workstation. The security information may simply identify one or more of the computer workstations, using the identity number, and thereafter only allow access to the or each data file by means of the or each computer workstation so specified. Thus, where the passenger knows the passenger seat 5 at which he will be seated, the information on his boarding pass (including seat number) can be used to generate the security information and so ensure that his own file or files can only be accessed from the specified computer workstation. The security information can comprise a combination of the above two methods, i.e. specifying one or more particular computer workstations and a password. Thus, even if a passenger is seated at a computer workstation identified by the security information, he will still be required to enter a password. This is desirable where particularly sensitive or confidential files are to be accessed, since problems may otherwise occur if the passenger is moved to a different seat, for example.

In both the first and second embodiments, a further level of security can also be provided if the or each data file is encrypted at the PC check-in terminal 13. Encryption can be performed using a conventional encryption algorithm so that the data file is converted to a different format. The encrypted data file is thereafter accessed by means of identifying the required decryption ‘key’ which causes the encrypted data file to be converted back to its original format. The ‘key’ can be in the form of a password, the principle of which is described above.

The following stages in the second embodiment are similar to the first embodiment, with the or each data file (including the added security information) being transferred from the PC check-in terminal 13 to the on-board computer system 7 by means of the bay port 15, the connecting cable 17, the connection port 11 of the aircraft 1, and the network connection 12. The passenger is able to access his file or files stored on the on-board computer system 7 depending on the security information attached to the or each file. A software program running on the on-board computer system 7 handles the security verification. Thus, if the security information simply defines the identity of the computer workstation, then the on-board computer system 7 is arranged so that computer workstations specified in the security information show a list of data files to which they have access. Then, the passenger simply selects the required file and begins working as normal. If the security information defines a password, either alone or together with data identifying a particular one or more computer workstations, the on-board computer system 7 is arranged so that the display screen 25 prompts the passenger to enter a password. Access is only enabled by the on-board computer system 7 if the correct password (attached to the or each data file) is entered. Otherwise, an error message appears and no access is allowed.

If the or each data file is encrypted, the required decryption key or password similarly has to be entered in order to access the or each data file.

In situations where several users wish to work co-operatively, that is, they wish to have access to and be able to work on one or more shared files, it will be necessary to have the or each data file patched through to the appropriate computer workstations.

Accordingly, it may be better to use a password system since then all that is required is for the same password to be used by the plurality of passengers, and if one or more members of the group moves from their assigned passenger seat 5, there is less of a security risk from a stranger sitting in the previously occupied passenger seat.

In another method of enabling co-operative working, it may be useful to allow one or more users to control security privileges whilst the aircraft 1 is in transit. Thus, one user may be designated as an administrator, and may determine whether additional users (not already able to access the or each data file) can be allowed to access files, or even whether currently enabled users should be barred from accessing one or more files.

Effectively, the system enables a LAN to be established over the network on the aircraft 1.

As with the first embodiment, at the end of the aircraft's journey, the data files stored on the on-board computer system 7 (some of which would have been modified by the passenger in the course of the journey) are transferred to a different PC check-in terminal at the destination airport. The user is prompted to enter his password (given to him at the initial check-in at the departure airport) whereafter the user's data files are written back to his portable computer.

In either of the first or second embodiments, if, during the course of the journey, the passenger wishes to print off a document or other information relating to a data file, a print request can be sent and stored in a print buffer of the on-board computer system 7. At the destination, when the on-board computer system 7 is connected to the PC check-in terminal 13, the print buffer sends the jobs to a printer located in the airport. Thus, when retrieving the portable computer 16 and updated files, the passenger can also collect his print jobs after identifying himself, e.g. using the password.

In a third embodiment, instead of the passenger transferring his file or files to the on-board computer system 7 electronically, i.e. using the connection with the PC check-in terminal 13, the passenger uses a portable storage medium to transfer his data files to the on-board computer system 13. The portable storage medium can be, for example, a CD-ROM, a floppy disk, or perhaps a so-called ZIP disk (the latter being a high density floppy disk). For the purposes of this explanation, the use of a floppy disk is assumed.

Prior to boarding the aircraft, the passenger will have transferred his data file or files from the portable computer onto the floppy disk. The portable computer is then handed over to the airline staff or security as before, whereafter it is stored in the cargo hold. The floppy disk is then carried onto the aircraft 1 by the passenger. Once on the aircraft 1, the passenger sits in one of the passenger seats and enables the computer workstation as before.

As with the first method, the passenger is provided with a password at the check-in desk. Upon entering the password at the computer workstation, the passenger inserts the floppy disk into the disk drive 37 provided within the passenger seat 5 directly in front of the passenger. By entering the password, the passenger is allowed to access a predetermined area of memory on the on-board computer system 7, this area of memory having being specifically assigned to the passenger at the time of check-in. No other passenger is able to access the same area of memory unless they have access to the same password.

Accordingly, the passenger is able to access and operate on the files by transferring them from the floppy disk to the on-board computer system. Co-operative working is enabled if a plurality of passengers input the same password, the same area of assigned memory on the on-board computer system thereafter being accessible. Once the user is finished operating on the or each file, for example when the aircraft 1 has landed, the passenger simply copies the files back to the floppy disk in the disk drive 37. The floppy disk is then removed from the disk drive 37, carried off the aircraft 1, and can be inserted in a disk drive of the portable computer (when retrieved from the cargo hold) so that the modified files can be updated.

The user's account is erased shortly after the destination airport is reached so that any data files present on the on-board computer 7 are removed.

The above three methods provide an efficient way in which passengers are able to access and work on electronic data files whilst on a passenger vehicle or craft where it is not possible or preferable for personal/portable computer devices to be operated in the passenger compartment of the vehicle or craft. By means of providing an on-board computer system and a plurality of dedicated computer workstations, an on-board network is provided which passengers can use when required. Given that co-operative working is facilitated by the provision of such an on-board network, i.e. with ad-hoc networks being set up by means of users specifying a shared password or identifying the seats in which they will be located, efficient operation is ensured.

What is claimed is:

1. A method of providing access to at least one data file using a computer system on-board a passenger vehicle or craft, said on-board computer system being accessible by means of a plurality of on-board computer workstations, the method comprising the steps of:
receiving into said on-board computer system at least one data file previously stored in a personal computer; and
enabling access to the at least one data file in said on-board computer system by means of at least one of the on-board computer workstations, which access is enabled in accordance with identification information inputted to said on-board computer system.

2. A method according to claim 1, wherein the step of receiving into said on-board computer system at least one data file previously stored in a personal computer comprises receiving said at least one data file from a check-in computer system to which said at least one data file has been transferred from a personal computer.

3. A method according to claim 2, wherein the identification information inputted to said on-board computer system is received with said at least one data file.

4. A method according to claim 3, wherein the identification information inputted to said on-board computer system identifies at least one on-board computer workstation, said at least one data file thereafter being accessible from said on-board computer system only by means of those on-board computer workstations specified in the identification data.

5. A method according to claim 4, wherein the identification information inputted to said on-board computer system relates to a user's predetermined seat number, said at least one data file thereafter being accessible from said on-board computer system only by means of the at least one on-board computer workstation associated with the user's predetermined seat number.

6. A method according to claim 3, wherein the identification information inputted to said on-board computer system identifies a user password associated with said at least one data file, said at least one data file thereafter being accessible from said on-board computer system only by means of those on-board computer workstations where the password is entered using an input device associated with the workstation.

7. A method according to claim 6, further comprising determining if said at least one data file is encrypted, and in the event of a positive determination, decrypting the at least one encrypted data file at the on-board computer system in accordance with a decryption password entered at at least one of the on-board computer workstations, said at least one decrypted data file being accessible only by means of those computer workstations where the decryption password is entered.

8. A method according to claim 1, wherein the step of receiving into said on-board computer system at least one data file previously stored in a personal computer comprises operating a reading device on-board the vehicle or craft to read said at least one data file from a portable storage medium, to which said at least one data file was previously transferred from the personal computer, to said on-board computer system.

9. A method according to claim 1, further comprising transferring said at least one data file from the on-board computer system to a personal computer external to the vehicle or craft.

10. A method of transferring at least one data file to a computer system on-board a passenger vehicle or craft, which on-board computer system is accessible by means of a plurality of on-board computer workstations, the method comprising the steps of:
transferring the at least one data file from a personal computer to the on-board computer system; and
providing identification information to said on-board computer system so as to indicate at least one on-board computer workstation by which said at least one data file may be accessed.

11. A method according to claim 10, wherein the step of transferring said at least one data file from the personal computer to said on-board computer system comprises: transferring said at least one data file from the personal computer to a check-in computer system; at the check-in computer system, adding the identification information to said at least one data file; and transferring said at least one data file and the added identification information to said on-board computer system.

12. A method according to claim 11, wherein the step of adding identification information to said at least one data file comprises adding data identifying at least one of the on-board computer workstations such that said at least one data file is thereafter accessible from the on-board computer only by means of those on-board computer workstations specified in the identification data.

13. A method according to claim 12, wherein the check-in computer system is located external to the vehicle or craft, and the identification data is generated in accordance with a user's check-in information.

14. A method according to claim 13, wherein the identification data is generated in accordance with the user's predetermined seat number such that said at least one data file is accessible only by means of those on-board computer workstations associated with the user's seat number.

15. A method according to claim 11, wherein the step of adding identification information to said at least one data file comprises assigning a user password to said at least one data file such that said at least one data file is thereafter accessible from said on-board computer system only by means of those on-board computer workstations to which the user password is entered using an input device associated with the at least one workstation.

16. A method according to claim 15, wherein said at least one data file is encrypted prior to being transferred to the on-board computer system, and wherein said at least one data file may be decrypted in accordance with the user password being entered at at least one of the on-board computer workstations such that said at least one decrypted data file is accessible only by means of those computer workstations where the user password is entered.

17. A method according to claim 15, wherein the check-in computer system is located external to the passenger vehicle or craft, the user password being specific to the user who transfers said at least one data file to the check-in computer system.

18. A method according to claim 17, wherein the user password is generated randomly at the check-in computer system and is thereafter identified to the user.

19. A method according to claim 18, wherein, after the user password is randomly generated, the user password is printed onto a pass for user collection.

20. A method according to claim 17, wherein the user password is specified by the user prior to boarding the vehicle or craft.

21. A method according to claim 11, wherein the step of adding identification information to said at least one data file comprises (i) adding, to said at least one data file, data specifying at least one of the on-board computer workstations, and (ii) assigning a user password to said at least one data file, such that said at least one data file may thereafter be accessed from the on-board computer only by means of those on-board computer workstations which are specified in the added data, and to which the user password is entered using an input device associated with the at least one workstation.

22. A method according to claim 10, wherein the step of transferring said at least one data file from the personal computer to said on-board computer system comprises: transferring said at least one data file from the personal computer to a portable storage medium for subsequent transfer to said on-board computer system by means of an on-board reading device.

23. A method according to claim 22, wherein the portable storage device is a CD-ROM so as to enable subsequent transfer by means of an on-board CD-ROM reading device.

24. A method according to claim 22, wherein the portable storage device is a floppy disk so as to enable subsequent transfer by means of an on-board floppy disk drive.

25. A computer network on-board a passenger vehicle or craft, the computer network comprising: a first data port; an on-board computer system connected to the first port; and a plurality of on-board workstations connected to said on-board computer system, said on-board computer system being arranged to receive at least one data file from a personal computer by means of the first port, and to enable access to the at least one data file on said on-board computer system by means of at least one on-board computer workstation, said on-board computer system being arranged to enable access in accordance with identification information contained in the at least one data file.

26. A computer network according to claim 25, wherein the identification information specifies at least one of the on-board computer workstations, the on-board computer system being arranged to enable access to said at least one data file only by means of those computer workstations specified.

27. A computer network according to claim 25, wherein the identification information comprises a user password assigned to said at least one data file, said on-board computer system allowing access to said at least one data file by means of only those on-board computer workstations where the user password is entered using an input device associated with the at least one workstation.

28. A computer network according to claim 25, wherein said first data port is configured to be connectable to an external check-in computer system to which the personal computer can be connected.

29. A computer network according to claim 25, wherein said first data port is a storage media reading device arranged to read data files from a portable storage device.

30. A computer network according to claim 29, wherein said reading device is a disk drive.

31. A computer network according to claim 25, wherein said first data port is further arranged to transmit data from said on-board computer system to a personal computer located external to the vehicle or craft.

32. A computer network according to claim 25, wherein the on-board computer workstations each comprise a display and a user input device.

33. A computer network according to claim 32, wherein said display is mounted on the reverse side of a passenger seat.

34. A computer network according to claim 32, wherein said user input device comprises a keyboard mounted on a frame pivotally attached to the reverse side of a passenger seat, the frame being pivotable between a first position whereby the keyboard can be operated, and a second position whereby the keyboard is stowed away.

35. A passenger vehicle comprising a computer network according to claim 25.
